(19) United States
(12) Patent Application Publication
(10) Pub. No.: US 2017/0362408 A1
(43) Pub. Date: Dec. 21, 2017

(54) POLYMER COMPOSITIONS AND ADDITIVES

(71) Applicant: Imerys Minerals Limited, Par Cornwall (GB)

(72) Inventors: Sara CAMMARANO, St. Austell Cornwall (GB); Michael BIRD, St. Austell Cornwall (GB)

(21) Appl. No.: 15/532,689

(22) PCT Filed: Nov. 26, 2015
(86) PCT No.: PCT/GB2015/053599

§ 371 Date: Jun. 2, 2017

(30) Foreign Application Priority Data
Dec. 3, 2014 (GB) 1421483.7

(51) Int. Cl. C08K 3/34; C08K 3/36; C08J 3/22; C08J 5/18

(52) U.S. Cl. CPC C08K 3/34; C08J 5/18; C08K 3/36; C08J 3/226; C08K 2201/014; C08J 2323/04

(57) ABSTRACT

An antiblocking additive for use in polymer films, a masterbatch and polymer resin comprising the antiblocking additive, a polymer article, for example, a film, formed from the polymer resin, a talc particulate for use in or as antiblocking additive, and mineral blends for use in or as antiblocking additive.

### TECHNICAL FIELD

The present invention is directed to an antiblocking additive for use in polymer films, to a masterbatch and polymer resin comprising the antiblocking additive, to a polymer article, for example, a film, formed from the polymer resin, to a talc particulate for use in or as antiblocking additive, and to mineral blends for use in or as antiblocking additive.

### BACKGROUND OF THE INVENTION

It is known to incorporate particulate inorganic materials, such as ground inorganic minerals into polymer compositions for a variety of purposes. One use of such particulate materials is as an antiblocking agent in polymer compositions such as polymer films. For example, talc is commonly added as antiblocking agent to polymer compositions which are to be formed into polymer film. “Blocking” is the term which is used to describe the unwanted adhesion between two polymer surfaces, usually films. “Antiblocking agents” are typically added to polymer compositions to reduce or eliminate this effect in the end product. Particulate materials may also be added to impart other properties to the polymer composition, such as mechanical strength.

However, the addition of filler as anti-blocking agent may adversely affect the optical properties of the composition, such as haze and clarity. Thus, there is ongoing need to provide new antiblocking additives.

Another important factor in the production of compositions and articles which incorporate a particulate material is the cost of the particulate material. Whilst inexpensive antiblocking filler materials are available, it would be desirable to provide further inexpensive particulate materials having desirable properties across a variety of end uses.

### SUMMARY OF THE INVENTION

According to a first aspect, the present invention is directed to an antiblocking additive for use in polymer films, comprising a blend of a first inorganic particulate material selected from talc and/or diatomaceous earth, and a second inorganic particulate material selected from perlite and/or quartz.

According to a second aspect, the present invention is directed to a masterbatch comprising polymer and/or polymer precursor(s) and an anti blocking additive according to the first aspect.

According to a third aspect, the present invention is directed to a polymer resin composition comprising a polymer and an antiblocking additive according to the first aspect.

According to a fourth aspect, the present invention is directed to a polymer article formed from the polymer resin composition according to the third aspect.

According to a fifth aspect, the present invention is directed to a polymer film comprising an antiblocking additive comprising first and second inorganic particulate materials, wherein the haze (%) of the polymer film is (i) less than that expected from the law of mixtures of the first and second inorganic particulate materials, and/or (ii) less than when made from either the first and second inorganic particulate material alone.

According to a sixth aspect, the present invention is directed to the use of a blend of a first inorganic particulate material selected from talc and/or diatomaceous earth, and a second inorganic particulate material selected from perlite and/or quartz, as antiblocking additive in a polymer resin or polymer film formed therefrom.

According to a seventh aspect, the present invention is directed to a talc particulate material for use in an antiblocking additive for a polymer film, wherein the talc particulate is milled under conditions to increase the morphological irregularity of the talc particulate whereby the haze and/or clarity of a polymer film comprising the talc particulate is improved compared to a comparable polymer film comprising talc particulate which has not been milled under said conditions and is morphologically more regular.

According to an eighth aspect, the present invention is directed to a process for improving an optical property of a polymer film comprising quartz and/or perlite, said process comprising adding thereto, during manufacture of the polymer film, talc and/or diatomaceous earth.

### BRIEF DESCRIPTION OF THE DRAWINGS

FIG. 1 is a graph summarizing the haze of polymer films according to the Examples.

FIG. 2 is a graph summarizing the clarity of polymer films according to the Examples.

FIG. 3 is a graph summarizing the blocking force of polymer films according to the Examples.

FIG. 4 is a graph summarizing the reblocking force of polymer films according to the Examples.

### DETAILED DESCRIPTION OF THE INVENTION

The present invention is based, at least in part, on the surprising finding that inorganic particulate materials can be combined for use in or as an antiblocking additive, enabling benefits in the optical properties of polymeric articles, such as polymer films, comprising the antiblocking additive, whilst maintaining or even improving antiblocking performance. For example, in the certain embodiments, the haze of a polymer film comprising first and second inorganic particulate materials is less than the law of mixtures of the first and second inorganic particulate material and/or is less than when made from either the first and second inorganic particulate material alone.

### Antiblocking Additive

The antiblocking additive, and components thereof, are suitable for use in polymer articles, such as polymer films and the like. The first inorganic particulate material is selected from talc and/or diatomaceous earth (D.E.). In certain embodiments, the first inorganic particulate material is talc. In certain embodiments, the first inorganic particulate material is D.E. In certain embodiments, the first inorganic particulate material is a combination, e.g., mixture, of talc and D.E.

In certain embodiments, the talc may be natural talc, synthetic talc, or a combination thereof.

As used herein, the term “natural talc” means talc derived from a natural resource, i.e., natural talc deposits. Natural talc may be either the magnesium silicate of formula Si₄Mg₃O₁₀(OH)₂, which is arranged as a stack of laminae, or the mineral chlorite (hydrated magnesium aluminium silicate), or a mixture of the two. Natural talc occurs as rock composed of talc crystals.

As used herein, the term “synthetic talc” means talc that has been synthesized using a man-made synthetic process. In certain embodiments, the synthetic talc particulate is one or more of:

(1) synthetic talc prepared in accordance with WO-A-2008/009800 and U.S.-A-2009/0253569, the entire contents of which are hereby incorporated by reference. More particularly, a talcose composition of synthetic mineral particles which contain silicon, germanium and metal, have a crystalline and lamellar structure, and are of formula —(SiₓGe₁₋ₓ)₄M₃O₁₀(OH)₂—, M denoting at least one divalent metal and having the chemical formula Mg_{y(1)}Co_{y(2)}Zn_{y(3)}Cu_{y(4)}Mn_{y(5)}Fe_{y(6)}Ni_{y(7)}Cr_{y(8)}; each y (i) representing a real number of the interval [0; 1], such that

$${\sum }_{i = 1}^{8} y ( i ) = 1$$

x being a real number of the interval [0; 1], obtainable by a process which comprises subjecting a composition comprising swelling TOT-TOT (tetrahedron-octahedron-tetrahedron) interlayer particles to an anhydrous thermal treatment which is carried out at a pressure of less than 5 bar for a period and at a treatment temperature, greater than 300° C., with appropriate conditions selected to obtain the crystallinity and stability desired for said synthetic mineral particles containing silicon, germanium and metal that are to be prepared.

(2) synthetic talc prepared in accordance with WO-A-2008/009801 and U.S.-A-2009/0252963, the entire contents of which are hereby incorporated by reference. More particularly, a synthetic talc composition comprising talc particles of the formula Si₄Mg₃O₁₀(OH)₂, wherein said composition is characterized in that an X-ray diffraction analysis of said talc particles yields a diffractogram having the following characteristic diffraction peaks: a peak located at 9.40-9.68 Å, corresponding to a plane (001); a peak located at 4.50-4.60 Å, corresponding to a plane (020); a peak located at 3.10-3.20 Å, corresponding to a plane (003); a peak located at 1.50-1.55 Å, corresponding to a plane (060). In certain embodiments, the diffraction peak corresponding to the plane (001) is located at a distance of the order of 9.40-9.43 Å. In certain embodiments, said talc particles have a particle size less than 500 nm, for example, a particle size of from 20 nm to 100 nm, as determined transmission electron microscopy, or any suitable method which gives substantially the same result;

(3) synthetic talc prepared in accordance with WO-A-2008/009799 and U.S.-A-2009/0261294, the entire contents of which are hereby incorporated by reference. More particularly, a talcose composition that comprises synthetic mineral particles containing silicon, germanium and metal of formula —(SiₓGe₁₋ₓ)₄M₃O₁₀(OH)₂— in which: M denotes at least one divalent metal and has the formula Mg_{y(1)}Co_{y(2)}Zn_{y(3)}Cu_{y(4)}Mn_{y(5)}Fe_{y(6)}Ni_{y(7)}Cr_{y(8)}; each y(i) being a real number of the interval [0; 1], such that

$${\sum }_{i = 1}^{8} y ( i ) = 1$$

wherein x is a real number of the interval [0; 1], said composition being characterized in that in an X-ray diffraction analysis of said synthetic mineral particles containing silicon, germanium and metal, a diffractogram having the following characteristic diffraction peaks is obtained: a peak located at a distance of the order of 9.40-9.68 Å, for a plane (001); a peak located at 4.50-4.75 Å, for a plane (020); a peak located at 3.10-3.20 Å, for a plane (003); a peak located at 1.50-1.55 Å, for a plane (060);

(4) synthetic talc prepared in accordance with WO-A-2012/085239 and U.S.-A-2013/0343980, the entire contents of which are hereby incorporated by reference. More particularly, a composition comprising synthetic talc mineral particles, obtainable by a process comprising: preparing a hydrogel precursor of said synthetic mineral particles, subjecting said hydrogel to a hydrothermal treatment, characterized in that performing at least one of said hydrothermal treatment step by adding at least one carboxylate salt in the treatment medium, said carboxylate salt having the formula R—COOM′, wherein: M′ is a metal selected from the group consisting of Na and K, and R is selected from H and alkyl groups having less than 10 carbon atoms. In certain embodiments, R is chosen from the group consisting of H, CH₃—, and —CH₃—CH₂—CH₂—. The temperature may be between 150° C. and 600° C., for example, between 200° C. and 400° C.;

(5) synthetic talc formed by the precipitation reaction of water soluble alkali metal silicate, e.g., sodium silicate, and a water soluble magnesium salt such as, for example, magnesium chloride, magnesium nitrate or magnesium sulfate; and

(6) synthetic talc prepared in accordance with international patent application PCT/FR2012/051594, the entire contents of which are hereby incorporated by reference. More particularly, a synthetic talc composition comprising synthetic mineral particles and is characterized in that an X-ray diffraction analysis of said talc particles yields a diffractogram having the following characteristic diffraction peaks: a peak located at 9.40-9.90 Å, corresponding to a plane (001); a peak located at 4.60-4.80 Å, corresponding to a plane (002); a peak located at 3.10-3.20 Å, corresponding to a plane (003); a peak located at 1.51-1.53 Å, corresponding to a plane (060), and wherein the intensity of a diffraction peak characteristic of a plane (002) is greater than the intensity of the corresponding signal of a plane (020), located at 4.40-4.60 Å, and wherein the ratio between the intensity of a diffraction peak characteristic of a plane (001) and the intensity of a diffraction peak characteristic of a plane (003) is comprised between 0.60 and 1.50.

In certain embodiments, the talc particulate material is milled in order to increase the morphological irregularity of the talc particles. It has surprisingly been found that use of a talc particulate having increased morphological irregularity as antiblocking additive, or as a component of an antiblocking additive, can improve the optical properties of polymer film. For example, benefits in haze and/or clarity may be obtained, whilst maintaining or even improving antiblocking performance. The improvement may be determined by comparing the haze and/or clarity of a polymer film comprising said talc particulate with a polymer film comprising (the same amount of) a talc particulate which is morphologically more regular, having not been milled under the milling conditions described above to increase the morphological irregularity of the talc particles. Thus, in certain embodiments, there is provided a talc particulate material for use in an antiblocking additive for a polymer film, wherein the talc particulate is milled under conditions to increase the morphological irregularity of the talc particulate whereby the haze and/or clarity of a polymer film comprising the talc particulate is improved compared to a comparable polymer film comprising talc particulate which has not been milled under said conditions and is morphologically more regular.

D.E. is, in general, a sedimentary biogenic silica depost comprising the fossilized skeletons of diatoms, one-celled algae-like plants that accumulate in marine or freshwater environment, and typically has a honeycomb silica structure. The D.E. may comprise up to about 90% SiO₂ (by XRF chemical analysis) mixed with other substances, for example, various metal oxides, such as but not limited to Al, Fe, Ca and Mg oxides.

In certain embodiments, the D.E. is obtained from a freshwater source. In certain embodiments, the D.E is obtained from a saltwater source.

According to certain embodiments, the D.E. includes or is at least one of calcined diatomaceous earth and flux-calcined diatomaceous earth.

The D.E. may be a commercially available D.E. product. For example, the D.E. may be a material under the Celite (RTM) trade name available from Imerys Filtration Minerals.

The D.E. may comprise mineral impurities. The impurities may, for example, be present in amount of less than about 5%, for example, less than about 4%, 3%, 2%, or 1%, by weight of the D. E. The impurities may be present in amount of less than about 0.5% by weight of the D. E.

The D.E. may possess at least one property including, but not limited to, high brightness, low yellowness, low oil absorption, low alkali content, low Fe₂O₃ content, low Al₂O₃ content, fine particle size, low crystalline silica content, low porosity, and beneficial color characteristics.

The D.E. may have a high SiO₂ content. In certain embodiments, the D.E. comprises at least about 90% SiO₂ (by XRF chemical analysis). In certain embodiments, the D.E. comprises at least about 95% SiO₂. In certain embodiments, high SiO₂ content results in high brightness.

The D.E. may have a low Fe₂O₃ content. In certain embodiments, the D.E. comprises less than about 1% Fe₂O₃ (by XRF chemical analysis). In certain embodiments, the D.E. comprises less than about 0.5% Fe₂O₃. In certain embodiments, the D.E. comprises less than about 0.4% Fe₂O₃ In certain embodiments, low Fe₂O₃ content results in low yellowness.

The D.E. may have low alkali content and/or low Al₂O₃ content. In certain embodiments, the D.E. comprises less than about 2% Al₂O₃ (by XRF chemical analysis). In certain embodiments, the D.E. comprises less than about 1% Al₂O₃. In certain embodiments, the D.E. comprises less than about 5% alkali content (by XRF chemical analysis) . In certain embodiments, the D.E. comprises less than about 2% alkali content. In certain embodiments, the D.E. comprises less than about 1% alkali content.

The D.E. may have low oil absorption. In certain embodiments, the D.E. has an oil absorption of not greater than about 100% by weight (i.e., 100 g of oil per 100 g of D.E). In certain embodiments, oil absorption is not greater than about 85%. In certain embodiments, oil absorption is not greater than about 80%. In certain embodiments, oil absorption is not greater than about 75%. Oil absorption may be determined in accordance with ISO 787 Part 5.

The D.E. may have a fine particle size. In certain embodiments, the median particle diameter (i.e., d₅₀) of the particles comprising the D.E. is not greater than about 20 μm. In certain embodiments, the median particle diameter is not greater than about 16 μm. In certain embodiments, the median particle diameter is not greater than about 10 μm. In certain embodiments, the median particle diameter is not greater than about 8 μm.

In certain embodiments, the median particle diameter is not greater than about 6 μm. In certain embodiments, the median particle diameter is not greater than about 5 μm. In certain embodiments, the median particle diameter is not greater than about 4 μm.

In certain embodiments, the d₉₀ of the D.E. is not greater than about 50 μm. In certain embodiments, the d₉₀ is not greater than about 40 μm. In certain embodiments, the d₉₀ is not greater than about 30 μm. In certain embodiments, the d₉₀ is not greater than about 20 μm. In certain embodiments, the d₉₀ is not greater than about 15 μm.

In certain embodiments, the d₉₇ of the D.E. is not greater than about 80 μm. In certain embodiments, the d₉₇ is less than about 70 certain embodiments. In certain embodiments, the d₉₇ is less than about 60 μm. In certain embodiments, the d₉₇ is less than about 50 μm. In certain embodiments, the d₉₇ is less than about 40 μm.

The D.E. may have low crystalline silica content. In certain embodiments, the crystalline silica is quartz. In certain embodiments, the D.E. comprises less than about 1% crystalline silica. In certain embodiments, the D.E. comprises less than about 0.5% crystalline silica. In certain embodiments, the D.E. comprises less than about 0.2% crystalline silica. In certain embodiments, the D.E. comprises less than about 0.1% crystalline silica.

The D.E. may have low porosity. In certain embodiments, the average pore volume of the particles comprising the D.E. is not more than about 3 mL/g. In certain embodiments, the average pore volume is less than 2 mL/g. In certain embodiments, the average pore volume is less than 1.5 mL/g. In certain embodiments, the median pore diameter of the particles comprising the D.E. is not more than about 3 certain embodiments. In certain embodiments, the median pore diameter is less than 2 certain embodiments. In certain embodiments, the median pore diameter is less than 1.5 certain embodiments. In certain embodiments, the surface area of the D.E. is not more than about 8 m²/g. In certain embodiments, the surface area is less than 6 m²/g.

Pore volume can be measured with an AutoPore IV 9500 series mercury porosimeter from Micromeritics Instrument Corporation (Norcross, Ga., USA), which can determine pore diameters ranging from 0.006 to 600 μm. As used to measure the pore volume of the diatomaceous earth products disclosed herein, that porosimeter's contact angle was set at 130 degree, and the pressure ranged from 0 to 33000 psi.

BET surface area refers to the technique for calculating specific surface area of physical absorption molecules according to Brunauer, Emmett, and Teller (“BET”) theory. BET surface area may be measured by any appropriate measurement technique. In one embodiment, BET surface area can be measured with a Gemini III 2375 Surface Area Analyzer, using pure nitrogen as the sorbent gas, from Micromeritics Instrument Corporation (Norcross, Ga., USA).

The D.E. may have beneficial color characteristics. In certain embodiments, the D.E. has an L-value of not less than about 90. In certain embodiments, the L-value is not less than about 92. In certain embodiments, the L-value is not less than about 95. In certain embodiments, the L-value is not less than about 96. In certain embodiments, the D.E. has a b-value of not greater than about 5. In certain embodiments, the b-value is not greater than about 4. In certain embodiments, the b-value is not greater than about 3. In certain embodiments, the D.E. has an a-value of not greater than about 0.5. In certain embodiments, the a-value is not greater than about 0.4. In certain embodiments, the a-value is not greater than about 0.3.

Hunter L-, b- and a-values may be determined using a Spectro/plus Spectrophotometer (Color and Appearance Technology, Inc., Princeton, N.J.). L-, a-, and b-values rank the whiteness, red/green, and blue/yellow values spectrophotometrically by measuring the reflection of light off of a colored sample. The desired values for L, a, and b may be different for various particulate mineral materials and intended uses; values of L, a, and b may be considered independently from each other such that, for example, relatively small changes in one value (such as b) may be highly desirable even with relatively larger changes in another value (such as L). L is numbered between 0 and 100, with 0 being a completely black sample and 100 being a completely white sample. The a-value is the red/green value which is a positive number for red samples (the more positive, the redder) and negative for green samples (the more negative, the greener). The b-value is similar to the a-value but looks at the blue/yellow values of the material. Positive samples are yellow, negative samples are blue. The more positive or negative the number, the more yellow or blue, respectively. Blue light brightness (“BLB”) may also be calculated from Hunter scale color data (L, a, b).

The second inorganic particulate material is selected from quartz and/or perlite. In certain embodiments, the second inorganic particulate material is quartz. In certain embodiments, the second inorganic particulate material is perlite. In certain embodiments, the second inorganic particulate material is a combination, e.g., a mixture of quartz and perlite.

As used herein, the term “quartz” means the crystalline mineral that contains silicon dioxide and is derived from natural resources, i.e., natural quartz deposits including, for example, quartz sand. For the avoidance of doubt, “quartz” does not include synthetic silica or natural amorphous silica.

The perlite employed in the present invention may be expanded perlite derived from perlite ore, which belongs to the class of natural glasses, commonly referred to as volcanic glasses, which are formed by the rapid cooling of siliceous magma and lava. Perlite ore is a hydrated natural glass containing typically about 72-75% SiO₂, 12-14% Al₂O₃, 0.5-2% Fe₂O₃, 3-5% Na₂O, 4-5% K₂O, 0.4-1.5% CaO (by weight) and small concentrations of MgO, TiO₂ and other metallic elements. Perlite ore is distinguished from other natural glasses by a higher content (2-10% by weight) of chemically bonded water, the presence of a vitreous, pearly luster, and characteristic concentric or arcuate onion skin-like (i.e., perlitic) fractures.

Process conditions for preparing expanded perlite are disclosed in U.S. Patent Application Publication No. 2006/0075930, the entire contents of which are hereby incorporated by reference. Generally, the expanded perlite employed in the compositions of the present invention can be prepared by methods which include crushing, grinding, milling screening and thermal expansion. For example, perlite ore is crushed, ground and separated to a predetermined particle size range. The separate material can then be heated in air, typically at a temperature of 870-1100° C. in an expansion surface. The expanded perlite can be prepared using conventional crushing, grinding and milling techniques, and can be separated to meet particle size requirements using conventional separating techniques.

In certain embodiments, the perlite is a non-expanded milled perlite. The non-expanded milled perlite can have very fine particle size, high blue light brightness and low oil absorption, thereby permitting much greater utility, particularly as anti-block filler products.

In certain embodiments, the non-expanded milled perlite is provided with a median particle size (i.e., d₅₀) less than about 10 μm. In certain embodiments, the median particle size is less than 5 μm, for example, less than 4 μm, or less than 3 μm, or less than 2 microns.

In certain embodiments, the non-expanded milled perlite is further characterized by having a Hunter L value of greater than 80, for example, greater than 82, or greater than 83, or greater than 85. Hunter L-value may be obtained in accordance with the methods described herein.

In certain embodiments, the non-expanded milled perlite has an oil absorption less than 70% by weight, for example, less than 60% by weight, or less than 55% by weight, or less than 50% by weight, or less than 45 percent by weight.

The first and/or second inorganic particulate materials may be subject to at least one sizing and/or classification step in order to provide a particulate having a desired particle size distribution. Suitable sizing and/or classification steps including crushing, grinding, milling and/or sieving, and/or wet-classification methods using a hydrocyclone and centrifuge. In certain embodiments, the first and/or second inorganic particulate material is ground to obtain a desired particle size distribution. Any suitable known grinding procedure may be employed. Grinding may include dry grinding by ball-milling with a suitable grinding media, for example, a ceramic grinding media. Alternatively, grinding may be by high-compression roller, fluid energy mill (also known as jet mill) hammer mill, or stirred media milling.

In certain embodiments, the first inorganic particulate material has a particle size distribution such that the d₅₀, in micron (μm), is less than the thickness of the polymer film (μm) in which it is to be incorporated. In certain embodiments, the d₅₀ is less than about 50 μm, for example, less than about 40 μm, or less than about 35 μm, or from about 0.1 to about 25 μm, or from about 0.25 to about 20 μm, or from about 0.5 to about 15 μm, or from about 1.0 to about 10 μm, or equal to or less than about 7.5 μm, or equal to or less than about 5.0 μm, or equal to or less than about 4.0 μm, or equal to or less than about 3.0 μm, or equal to or less than about 3.0 μm, or equal to or less than about 1.5 μm, or equal to or less than about 1.25 μm, or equal to or less than about 1.0 μm. In certain embodiments, the d₅₀ of the first inorganic particulate material is at least about 0.1 μm, for example, at least about 0.25 μm, or at least about 0.5 μm.

In certain embodiments, the top cut (also referred to as d₉₀) of the first inorganic particulate material is typically less than about 75 μm, for example, less than about 50 μm, or less than about 25 μm, or less than about 20 μm, or less than about 15 μm, or less than about 10 μm, or less than about 5 μm, or less than about 2 μm.

In certain embodiments, the second inorganic particulate material has a particle size distribution such that the d₅₀, in micron (μm), is less than the thickness of the polymer film (μm) in which it is to be incorporated. In certain embodiments, the d₅₀ is less than about 50 μm, for example, less than about 40 μm, or less than about 35 μm, or from about 0.1 to about 25 μm, or from about 0.25 to about 20 μm, or from about 0.5 to about 15 μm, or from about 1.0 to about 10 μm, or equal to or less than about 7.5 μm, or equal to or less than about 5.0 μm, or equal to or less than about 4.0 μm, or equal to or less than about 3.0 μm, or equal to or less than about 3.0 μm, or equal to or less than about 1.5 μm, or equal to or less than about 1.25 μm, or equal to or less than about 1.0 μm. In certain embodiments, the d₅₀ of the first inorganic particulate material is at least about 0.1 μm, for example, at least about 0.25 μm, or at least about 0.5 μm.

In certain embodiments, the top cut of the second inorganic particulate material is typically less than about 75 μm, for example, less than about 50 μm, or less than about 25 μm, or less than about 20 μm, or equal to or less than about 15 μm, or equal to or less than about 10 μm, or equal to or less than about 5 μm, or less than about 2 μm.

In certain embodiments, the first inorganic particulate has a d₅₀ of from about 1.0 to about 15 μm, and the second inorganic particulate has a d₅₀ of from about 0.5 to about 10 μm.

In certain embodiments, the first inorganic particulate is D.E. having a d₅₀ of from about 5.0 to about 15 μm, for example, from about 7.5 to about 13 μm, or from about 10 to about 12 μm, and the second inorganic particulate is quartz or perlite having a d₅₀ of from about 1.0 to about 5.0 μm, for example, from about 2.0 to about 4.0 μm.

In certain embodiments, the first inorganic particulate is talc having a d₅₀ of from about 2.0 to about 8.0 μm, for example, from about 3.0 to about 7.0 μm, or from about 4.0 to about 6.0 umm, and the second inorganic particulate is quartz or perlite having a d₅₀ of from about 1.0 to about 5.0 μm, for example, from about 2.0 to about 4.0 μm.

Unless otherwise stated, all particle size values pertaining to the inorganic particulate materials are specified as equivalent spherical diameters, and are determined by laser light particle size analysis using a CILAS (Compagnie Industrielle des Lasers) 1064 instrument. In this technique, the size of particles in powders, suspensions and emulsions may be measured using the diffraction of a laser beam, based on application of either Fraunhofer or Mie theory. The term “d₅₀” used herein is the value, determined in this way, of the particle diameter at which there are 50% by weight of the particles which have a diameter less than the d₅₀ value. The term “d₉₀” is the particle size value less than which there are 90% by weight of the particles. The preferred sample formulation for measurement of particle sizes using the CILAS 1064 instrument is a suspension in a liquid. The CILAS 1064 instrument normally provides particle size data to two decimal places, to be rounded up or down when determining whether the requirements of the present invention are fulfilled, or by other methods which give essentially the same result.

In certain embodiments, the first and/or second inorganic particulate material has a surface area, as measured using the BET nitrogen adsorption method, of less than about 10 m²/g and at least about 0.1 m²/g. The first and/or second inorganic particulate material may have a surface area ranging from at least about 1.0 m²/g to less than about 10.0 m²/g. In certain embodiments in which the first inorganic particulate material is D.E., the D.E may have a surface area of less than about 5 m²/g, for example, less than about 3.0 m²/g, or less than about 2.0 m²/g, and at least about 0.5 m²/g, for example, at least about 1.0 m²/g.

In certain embodiments, the second inorganic particulate material has a d₅₀ of from about 1.0 to about 5.0 μm, for example, from about 2.0 to 4.0 μm. In certain embodiments, the second inorganic particulate material is quartz having a d₅₀ of from about d₅₀ of from about 1.0 to about 5.0 μm, for example, from about 2.0 to 4.0 μm.

The first and/or second inorganic particulate material may have an oil absorption ranging from about 10 g/100 g to about 150 g/100 g, such as for example ranging from about 20 g/100 g to about 100 g/100 g, or greater than about 20 g/100 g, or greater than about 30 g/100 g. Oil absorption may be measured in accordance with ISO 787 Part 5. In certain embodiments, the first inorganic particulate material has an an oil absorption ranging from about 60 g/100 g to about 110 g/100 g, for example, from about 60 g/100 g to about 100 g/100 g. In certain embodiments, the first inorganic particulate material is D.E. having an oil absorption of from about 80 g/100 g to about 100 g/100 g. In certain embodiments, the first inorganic particulate is talc having an oil absorption of from about 60 g/100 g to about 80 g/100 g.

The first and/or second inorganic particulate material may be subjected to at least one surface treatment process. This skilled artisan will readily know appropriate surface treatment processes. For example, the first and/or second inorganic particulate material may be subject to silanization, which may be used to render surfaces of the inorganic particulate material either more hydrophobic or hydrophilic. Silanization agents which are suitable for increasing the hydrophobic properties of the inorganic particulates may be selected from one or more of dimethyldichlorosilane, hexadimethylsilazane, butyltrichlorosilane, hexyltrichlorosilane, octyltrichlorosilane, octylmethyldichlorosilane, decyltrichlorosilane, dodecyltrichlorosilane, tridecyltrichlorosilane, dihexyldichlorosilane, dioctyldichlorosilane, octadecyltrichlorosilane, tributylchlorosilane, octyltrialkoxysilanes such as, tor example, octyltriethoxysilane and octyltrimethoxysilane, chloropropyltrialkoxysilanes such as, for example, chloropropyltrimethoxysilane and chloropropyltriethoxysilane, polydimethylsiloxane, 3-methacryloxypropyltriethoxysilane, vinyl trialkoxysilanes such as, for example, vinyl trimethoxy silane, vinyl triethoxy silane and vinyl triisopropoxy silane, and mixtures thereof. The vinyl functionalized silanes may also provide reactive sites for crosslinking of the filler with a polymer.

Silanization agents which are suitable for increasing the hydrophilic properties of the inorganic particulate may be selected from one or more of trimethoxysilyl ethyl amine, triethoxysilyl ethyl amine, tripropoxysilyl ethyl amine, tributoxysilyl ethyl amine, trimethoxysilyl propyl amine, triethoxysilyl propyl amine, tripropoxysilyl propyl amine, triisopropoxysilyl propyl amine, tributoxysilyl propyl amine, trimethoxysilyl butyl amine, triethoxysilyl butyl amine, tripropoxysilyl butyl amine, tributoxysilyl butyl amine, trimethoxysilyl pentyl amine, triethoxysilyl pentyl amine, tripropoxysilyl pentyl amine, tributoxysilyl pentyl amine, trimethoxysilyl hexyl amine, triethoxysilyl hexyl amine, tripropoxysilyl hexyl amine, tributoxysilyl hexyl amine, trimethoxysilyl heptyl amine, triethoxysilyl heptyl amine, tripropoxysilyl heptyl amine, tributoxysilyl heptyl amine, trimethoxysilyl octyl amine, triethoxysilyl octyl amine, tripropoxysilyl octyl amine, tributoxysilyl octyl amine, and mixtures thereof.

Other agents suitable for increasing the hydrophilic properties of the inorganic particulate include triethanolamine (TEA), 2-amino-2-methyl-1-propanol, AMP-95™ (2-amino-2-methyl-1-propanol formulation containing 5% water), and mixtures thereof.

In certain embodiments, the first inorganic particulate material is talc and the second inorganic particulate material is perlite or quartz. In certain embodiments, the first inorganic particulate material is talc and the second inorganic particulate material is perlite. In certain embodiments, the first inorganic particulate material is talc and the second inorganic particulate material is quartz.

In certain embodiments, the first inorganic particulate material is D.E. and the second inorganic particulate material is perlite or quartz. In certain embodiments, the first inorganic particulate material is D.E. and the second inorganic particulate material is perlite. In certain embodiments, the first inorganic particulate material is D.E. and the second inorganic particulate material is quartz.

In certain embodiments, the weight ratio of the first inorganic particulate material to the second inorganic particulate material is from about 1:4 to about 4:1, for example, from about 1:3 to about 3:1, or from about 1:2 to about 2:1, or from about 2:3 to about 3:2.

In certain embodiments, the weight ratio of the first inorganic particulate material to the second inorganic particulate material is from about 9:11 to about 11:9 or 1:1.

In certain embodiments, the first and second inorganic particulate materials constitute at least 80% by weight of the antiblocking additive, for example, at least about 85% by weight, or at least about 90% by weight, or at least about 95% by weight, or at least about 96% by weight, or at least about 97% by weight, or at least about 98% by weight, or at least about 99% by weight, or at least about 99.5% by weight of the antiblocking additive.

The antiblocking additive may contain additional components other than the first and second inorganic particulate materials. For example, the antiblocking additive may comprise up to about 10% by weight of an inorganic particulate material other than the first and second inorganic particulate materials, based on the total weight of the antiblocking additive, for example, from about 0.5 to 10% by weight of an inorganic particulate other than the first and second inorganic particulate materials. Other inorganic particulate materials include one or more further fillers selected from the group consisting of feldspar, nepheline, kaolin, wollastonite, christobalite, silica (synthetic or natural amorphous), calcium carbonate, volcanic ash, or glass. In certain embodiments, the antiblocking additive comprises less than about 5% by weight of an inorganic particulate material other than the first and second inorganic particulate materials, for example, less than about 1% by weight of an inorganic particulate material other than the first and second inorganic particulate materials, or less than about 0.5% by weight of an inorganic particulate material other than the first and second inorganic particulate materials, or less than about 0.1% by weight of an inorganic particulate material other than the first and second inorganic particulate materials. In certain embodiments, the antiblocking additive is substantially free of inorganic particulate material other than the first and second inorganic particulate material. By “substantially free” is meant that the antiblocking additive comprises no other inorganic particulate material or only a trace amount of other inorganic particulate material. The skilled artisan will understand a “trace amount” to mean an amount which is not quantifiable and, moreover, does not affect the properties of the antiblocking additive or the polymer composition in which it is incorporated.

### Masterbatch, Polymer Resin and Polymer Articles

As sated above, an aspect of the present invention is a masterbatch or polymer resin composition comprising the antiblocking additive described above and polymer and/or polymer precursor(s).

The polymer to be filled in accordance with the present invention includes homopolymers and/or copolymers, as well as cross-linked and/or entangled polymers.

In certain embodiments, the polymer to be filled is a thermoplastic polymer, for example, polyolefin such as polyethylene (including HDPE, LDPE and/or LLDPE) and polypropylene, polyester, polyamide, PVC, nylons, polystyrene, polyphenylene sulfide, polyoxymethylene and polycarbonate, and mixtures thereof.

The term “precursor” as applied to the polymer component will be readily understood by one of ordinary skill in the art. For example, suitable precursors may include one or more of: monomers, cross-linking agents, curing systems comprising, for example, cross-linking agents and promoters, or any combination thereof.

In certain embodiments, the polymer is a homopolymer or copolymer of a C₁-C₆ alkylene monomer, for example, a C₂-C₆ alkylene monomer, for example, ethylene, propylene or butylenes (including any isomeric forms thereof). In certain embodiments, the polymer is a homopolymer or copolymer of ethleyene, e.g., polyethylene. In certain embodiments, the polymer is a copolymer of ethylene and a C₁-C₆ alkylene monomer other than ethylene. In certain embodiments, the polymer is a copolymer of ethylene and an alkene monomer, for example, a C₂-C₂₀ alkene, for example, a C₂-C₁₂ alkene, or a C₆-C₁₀ alkene, for example, propene, butene, pentene, hexene, heptene, octane, nonene or decene. In certain embodiment, polymer is a copolymer of ethylene and octane.

Examples of polymers which may be used in accordance with the invention include, but are not limited to, linear low density polyethylene (LLDPE) and medium density grades thereof (m-LLDPE), high density polyethylene (HDPE), and low density polyethylene (LOPE).

Generally, HDPE is understood to be a polyethylene polymer mainly of linear, or unbranched, chains with relatively high crystallinity and melting point, and a density of about 0.96 g/cm³ or more. Generally, LDPE (low density polyethylene) is understood to be a highly branched polyethylene with relatively low crystallinity and melting point, and a density of from about 0.91 g/cm³ to about 0.94 g/cm. Generally, LLDPE (linear low density polyethylene) is understood to be a polyethylene with significant numbers of short branches, commonly made by copolymerization of ethylene with longer-chain olefins. LLDPE differs structurally from conventional LDPE because of the absence of long chain branching. Density may be determined in accordance with ISO1183.

In certain embodiments, the polymer resin composition comprises the antiblocking additive in an amount effective to modify the properties of the end polymer product, for example, its antiblocking properties, and/or its optical properties, such as haze and/or clarity, as desired. In certain embodiments, the polymer resin composition comprises from about 0.05 wt. % to about 50 wt. % of antiblocking additive, based on the total weight of the polymer resin composition. In certain embodiments, the polymer resin composition comprises from 0.1 wt. % to about 30 wt. % of antiblocking additive, for example, from about 0.1 wt. % to about 20 wt. %, or from about 0.1 wt. % to about 10 wt. %, or from about 0.5 wt. % to about 10 wt. %, or from about 1.0 wt. % to about 5 wt. %. In certain embodiments, the polymer resin composition comprises from about 50 to about 10,000 ppm antiblocking additive, for example, from about 500 to about 5,000 ppm antiblocking additive, or from about 1,000 to about 5,000 ppm antiblocking additive.

The polymer composition may further comprises may further comprise slipping agents (also known as slip aids), e.g., Erucamide, and process aids, e.g., Polybatch (RTM) AMF-705. Typically, slipping agent are added in amount of up to about 5 wt. %, based on the total weight of the polymer resin composition, for example, from about 0.1 wt. % to about 4 wt. %, or from about 0.5 wt. % to about 2 wt. %.

In certain aspects, a masterbatch is formed comprising polymer and/or polymer precursor and antiblocking additive and other optional additives, as described above, from which the polymer resin composition may be formed. Thus, in certain embodiments, the masterbatch may comprise a relatively greater amount of antiblocking additive then desired in the polymer resin, such that upon dilution of the masterbatch, e.g., with additional polymer and/or polymer precursor, a polymer resin composition with the desired level of antiblocking additive is formed.

The polymer resin composition of the present invention may be prepared by combining polymer with antiblocking additive. For example, preparation of the polymer resin compositions of the present invention can be accomplished by any suitable mixing method known in the art, as will be readily apparent to one of ordinary skill in the art. Such methods include dry blending of the individual components or precursors thereof and subsequent processing in a conventional manner. Certain of the ingredients can, if desired, be pre-mixed before addition to the compounding mixture.

In the case of thermoplastic polymer compositions, such processing may comprise melt mixing, either directly in an extruder for making an article from the composition, or pre-mixing in a separate mixing apparatus. Dry blends of the individual components can alternatively be directly injection moulded without pre-melt mixing.

The polymer composition can be prepared by mixing of the components thereof intimately together. The inorganic particulate antiblocking additive may then be suitably dry blended with the polymer and any desired additional components, before processing as described above.

For the preparation of cross-linked or cured polymer compositions, the blend of uncured components or their precursors, and, if desired, the inorganic particulate antiblocking additive and any desired additional component(s), will be contacted under suitable conditions of heat, pressure and/or light with an effective amount of any suitable cross-linking agent or curing system, according to the nature and amount of the polymer used, in order to cross-link and/or cure the fluoroelastomer polymer.

For the preparation of polymer compositions where the inorganic particulate antiblocking additive and any desired other component(s) are present in situ at the time of polymerisation, the blend of monomer(s) and any desired other polymer precursors, antiblocking additive and any other component(s) will be contacted under suitable conditions of heat, pressure and/or light, according to the nature and amount of the monomer(s) used, in order to polymerize the monomer(s) with the antiblocking additive and any other component(s) in situ. For example, where the inorganic particulate antiblocking additive is mixed with precursors of the polymer, the polymer will subsequently be formed by curing and/or polymerising the precursor components to form the desired polymer.

The polymer compositions may be prepared by compounding using any of the usual mixing devices such as roll mills and internal mixers. Generally, the temperature of the mixture being compounded should not rise above about 120° C.

For example, the polymer composition may be prepared by compounding on a two-roll mill, at temperatures between about room temperature and about 100° C., for example, between about 45° C. and 65° C. The mill is adjusted to rotate at the desired speed, and pre-formed fluoroelastomer is added. Processing aids, such as Carnauba wax, can be added also. Generally, a rise in temperature will occur due to the shear forces generated. The inorganic particulate antiblocking additive is then added. Typically, the inorganic particulate antiblocking additive is added as quickly as it can be absorbed by the polymer.

The mill can be adjusted to allow cross cutting and blending until a substantially homogeneous crepe is achieved. The crepe is then removed (e.g., by cutting) from the mill for subsequent processing. Then, for example, the resulting blend can be further compression moulded or injection moulded into useful shapes.

Suitable mould release agents will be readily apparent to one of ordinary skill in the art, and include fatty acids, and zinc, calcium, magnesium and lithium salts of fatty acids and organic phosphate esters. Specific examples are stearic acid, zinc stearate, calcium stearate, magnesium stearate, lithium stearate calcium oleate and zinc palmitate.

The resulting blend may then be cured. Suitable curing conditions will be readily apparent to one of ordinary skill in the art. Suitable curing agents include diamine, dihydroxy and peroxide based agents. Diamine based cure agents (such as hexamethylene diamine carbamate) and peroxide based cure agents (such as 2,5-dimethyl-2,5-di(t-butyl peroxy) hexane/triallylisocyanurate) typically added during compounding of the polymer and the inorganic particulate antiblocking additive.

The polymer resin compositions of the present invention can be processed to form, or to be incorporated in, articles of commerce in any suitable way. Such processing may include compression moulding, injection moulding, gas-assisted injection moulding, calendaring, vacuum forming, thermoforming, extrusion, blow moulding, drawing, spinning, film forming, laminating or any combination thereof. Any suitable apparatus may be used, as will be apparent to one of ordinary skill in the art.

In certain embodiments, the inorganic particulate antiblocking additive is compounded with a polymer, for example, a polymer masterbatch, such as LLDPE. The compounded compositions may further comprise slipping agents (for example, Erucamide) and process aids (for example, Polybatch® AMF-705). Polymer films may then be extruded using conventional extruding techniques.

One advantageous application of the polymer resin compositions of the present invention is as a polymer film. Unexpectedly, it has been found that combinations of different inorganic particulate materials incorporated in the polymer film may offer improvements in the optical properties of the polymer film, whilst maintaining acceptable antiblocking properties or even improving the antiblocking properties of the polymer film. For example, in certain embodiments, the haze of a polymer film comprising first and second inorganic particulate materials is less than the law of mixtures of the first and second inorganic particulate material and/or is less than when made from either the first and second inorganic particulate material alone. In other words, combining a first inorganic particulate material which, when used alone in a polymer film, results in relatively poor haze, with a second inorganic particulate material which, when used alone in a polymer film, results in relatively better haze (i.e., relative to the polymer film comprising the first inorganic particulate alone), results in a polymer film having better haze performance compared to the polymer film comprising only the first inorganic particulate material and the polymer film comprising only the second inorganic particulate. This is unexpected because according to the law of mixtures, a skilled person would expect the haze of the polymer film comprising both first and second inorganic particulate materials to be intermediate between the haze of the polymer film comprising only the first inorganic particulate and the haze of the polymer comprising only the second inorganic particulate material. In certain embodiments, the first and second inorganic particulate materials are as described above in connection with embodiments of the antiblocking additive of the present invention.

In certain embodiments, the unexpected finding means that the skilled artisan can improve an optional property of a polymer film, e.g., haze or clarity comprising quartz and/or perlite by adding thereto, during manufacture of the polymer film, talc and/or D.E.

In certain embodiments, the polymer film has a haze of less than about 6.0%, for example, less than about 5.0%, or less than about 4.5%, or less than about 4.0%, or less than about 3.5%, or less than about 3.0%. In certain embodiments, the polymer film has a haze of at least about 1.0%, for example, at least about 1.5%, or at least about 2.0%.

Additional, or alternatively, the polymer film may have a clarity of at least about 92.0%, or at least about 93.0%, or at least about 93.5%, or at least about 94.0%, or at least about 94.5%, or at least about 95.0%, or at least about 95.5%, or at least about 96.0%. In certain embodiments, the polymer film has a clarity of no greater than about 99.0%, for example, no greater than about 98.0%.

For the purposes of the present invention, haze and clarity are measured with a BYK-Gardner Haze-Gard Plus spectrophotometer in accordance with ASTM D1746.

In certain embodiments, the polymer film has a thickness of up to about 100 μm, for example, a thickness of from about 5 μm to about 75 μm, or from about 10 μm to about 50 μm, or from about 20 μm to about 45 μm, or from about 20 μm to about 40 μm, or from about 25 μm to about 40 μm, or from about 30 μm to about 45 μm, or from about 30 μm to about 40 μm.

### EXAMPLES

### Example 1

25 μm films were film blown from a series of compounded masterbatches comprising ethylene octene copolymer metallocene LLDPE grade, slip agent (Erucamide) and varying minerals. Each film had a minerals content of 3000 ppm and a slip agent content of 1000 ppm. Details of the minerals are provided in Table 1.

TABLE 1

| Mineral | Particle size, d₅₀ | Surface area (m²/g) | Oil absorption (g) |
|---|---|---|---|
| D.E. | 11.4 | 1.6 | 91 |
| Talc | 5.6 | 7.9 | 71 |
| Quartz | 3.5 | 7.5 | 32 |
| Perlite | 3.1 | 3.5 | 33 |

Films were blown using a Collin 180/30 extruder, with a 60 mm die and 0.8 mm die gap. Temperature profile: 240° C. at the die, 240, 240, 240, 240, 235, 220, 190° C. in the barrel. Screw speed: 75 rpm. Blow up ratio: 1:2.5. Haul off: 6.0 m min⁻¹. Lyflat: 225 mm. Samples conditioned at 23° C., 50% relative humidity for 48 hours before testing.

Eight films in total were blown—four containing a single mineral, and four containing a mineral blend.

The haze and clarity of each film was measured with a BYK-Gardner Haze-Gard Plus spectrophotometer in accordance with ASTM D1746.

Blocking/Reblocking force of each was measured in accordance with ASTM D3354.

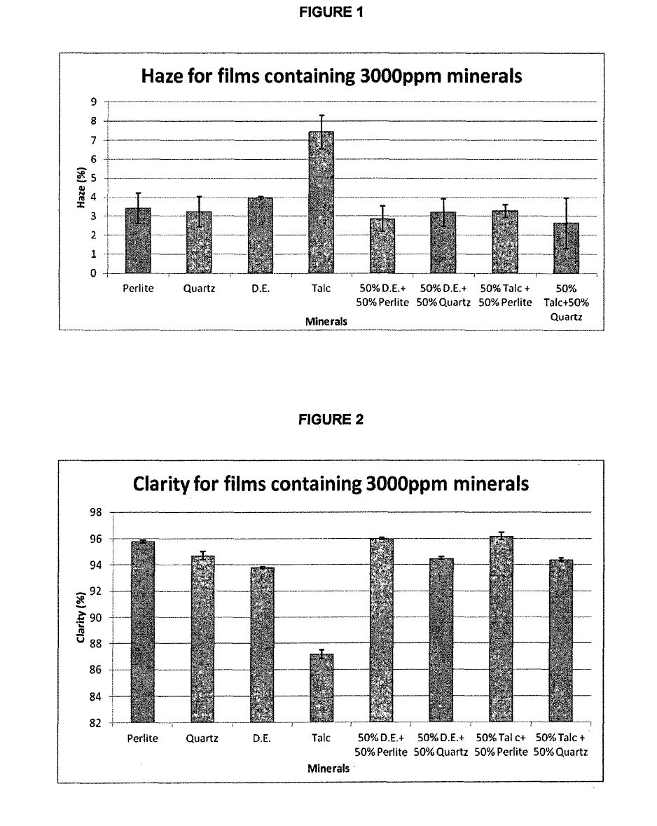

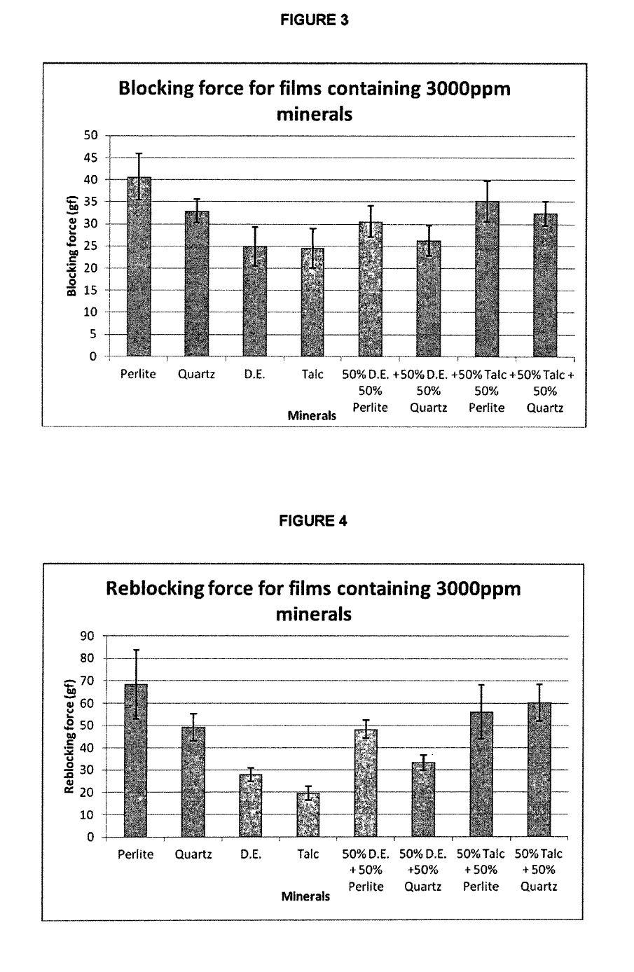

Details of the mineral blends and experimental results are summarized in FIGS. 1-4.

1. An antiblocking additive for use in polymer films, comprising a blend of a first inorganic particulate material selected from talc and diatomaceous earth, and a second inorganic particulate material selected from perlite and quartz.

2. An antiblocking additive according to claim 1, wherein:
(i) the first inorganic particulate material is talc and the second inorganic particulate material is perlite or quartz; or
(ii) the first inorganic particulate material is diatomaceous earth and the second inorganic particulate material is perlite or quartz.

3. An antiblocking additive according to claim 1, wherein the first inorganic particulate material is diatomaceous earth and the second inorganic particulate material is quartz.

4. An antiblocking additive according to claim 1, wherein the weight ratio of the first inorganic particulate material to the second inorganic particulate material is from about 1:4 to about 4:1.

5. An antiblocking additive according to claim 4, wherein the weight ratio of the first inorganic particulate material to the second inorganic particulate material is about 1:1.

6. An antiblocking additive according to claim 1, further comprising up to about 10 w % weight of an inorganic particulate material other than the first and second inorganic particulate materials.

7. An antiblocking additive according to claim 1, which is substantially free of inorganic particulate material other than the first and second inorganic particulate material.

8. A masterbatch comprising a polymer and/or polymer precursor(s) and an antiblocking additive according to claim 1.

9. A polymer resin composition comprising a polymer and an antiblocking additive according to claim 1.

10. A polymer resin composition according to claim 9, comprising from about 1 wt. % to about 50 wt. % of the antiblocking additive, based on the total weight of the polymer resin composition.

11. A polymer resin composition according to claim 10, wherein the polymer is a homo-or co-polymer of ethylene.

12. A polymer article formed from the polymer resin composition according to claim 9.

13. A polymer article according to claim 12, wherein the polymer article is a polymer film.

14. A polymer film according to claim 13, having a thickness between about 10 μm and 50 μm.

15. (canceled)

16. (canceled)

17. A talc particulate material for use in an antiblocking additive for a polymer film, wherein the talc particulate is milled under conditions that increase the morphological irregularity of the talc particulate.

18. A talc particulate according to claim 17 in combination with further inorganic particulate materials.

19. A process for improving an optical property of a polymer film comprising quartz and/or perlite, said process comprising adding thereto, during manufacture of the polymer film, talc and/or diatomaceous earth.

20. A process according to claim 19, wherein the optical property is haze or clarity.

21. A talc particulate according to claim 17, wherein a haze or clarity of a polymer film comprising the talc particulate is improved compared to a comparable polymer film comprising talc particulate which has not been milled under said conditions.
